(19) United States
(12) Patent Application Publication
(10) Pub. No.: US 2008/0242137 A1
(43) Pub. Date: Oct. 2, 2008

(54) SINGLE STEP OPERATION CONNECTOR ASSEMBLY

(75) Inventor: Ravi Shankar Mruthyunjaya, Banglore (IN)

Correspondence Address: PETER VOGEL;GE HEALTHCARE, 20225 WATER TOWER BLVD., MAIL STOP W492, BROOKFIELD, WI, 53045, US

(73) Assignee: General Electric Company, Schenectady, NY (US)

(21) Appl. No.: 11/693,806

(22) Filed: Mar. 30, 2007

(51) Int. Cl. H01R 13/62

(52) U.S. Cl. 439/310; 382/276

(57) ABSTRACT

A connector assembly is presented. The assembly includes a first connector including a pilot terminal and a plurality of first terminals. Further, the assembly includes a second connector including a plurality of second terminals, where the second connector is configured to be releasably coupled with the first connector. In addition, the assembly includes a housing disposed about the second connector and in operative association with the second connector. The assembly also includes a coupling mechanism in operative association with the second connector, where the coupling mechanism is configured to aid in coupling the first connector and the second connector with use of a first force, and where the coupling mechanism includes a lever mechanism having a Clevis mechanism. The pilot terminal is configured to facilitate coupling of the first connector and the second connector.

### BACKGROUND

The invention relates generally to connector assemblies, and more particularly to a connector assembly configured to couple and/or uncouple its connectors while using a substantially reduced coupling and/or uncoupling force.

Connector assemblies are currently employed in a wide variety of applications such as, but not limited to, medical imaging systems. More particularly, in medical imaging systems, need for faster and higher resolution imaging entails use of an increasing number of channels, consequently resulting in an increase in the number of pins in the connectors. Further, this increase in the number of pins in the connectors disadvantageously results in an increased force needed to engage and/or disengage the connectors in the connector assembly. Additionally, as reported by FAA William J. Hughes Technical Center (Jan. 15, 1996, pp. 14-43), ergonomic standards recommend an upper limit of about 15 to 20 kg force for engaging and/or disengaging the connectors in a connector assembly.

Presently available connector assemblies typically employ levers, cams, slides and a variety of mechanical devices to facilitate engaging connectors having a large number of terminals. However, use of these mechanical devices fails to circumvent problems associated with misalignment of connector pins, where the misalignment of the connector pins may occur due to improper initial alignment of the connectors or due to an inconsistently applied force. Additionally, use of the connector assemblies having an increased number of connector pins entails higher force requirements that may exceed regulatory requirements. In other words, the currently available connectors fail to facilitate the engaging and/or disengaging of the connectors with use of an appropriate force, while ensuring the connection is properly made along a mating axis without either connector becoming misaligned.

Additionally, in case of a medical emergency, it may be desirable to instantaneously engage or disengage the connectors in the connector assembly. Also, use of the currently available connector assemblies entails a minimum of two operations, a first operation to turn a lever and a second operation to disengage the connectors. Consequently, currently available connector assemblies disadvantageously fail to allow easy engagement and/or disengagement of the connectors in case of a medical emergency. Hence, the presently available techniques fail to facilitate a single operation emergency egress.

It may therefore be desirable to develop a robust technique and system for engaging and/or disengaging the connectors in a connector assembly. In particular, there is a need for a system that may be configured to aid in meeting the higher force requirements for engaging and/or disengaging the connectors in the connector assembly, while maintaining the force necessary below regulatory requirements, thereby simplifying the workflow and reducing fatigue of an operator operating the system. Furthermore, there is a need for a connecter assembly, which may facilitate a single step operation for the ergonomic ease of operation.

### BRIEF DESCRIPTION

In accordance with aspects of the present technique, a connector assembly is presented. The assembly includes a first connector including a pilot terminal and a plurality of first terminals. Further, the assembly includes a second connector including a plurality of second terminals, where the second connector is configured to be releasably coupled with the first connector. In addition, the assembly includes a housing disposed about the second connector and in operative association with the second connector. The assembly also includes a coupling mechanism in operative association with the second connector, where the coupling mechanism is configured to aid in coupling the first connector and the second connector with use of a first force, and where the coupling mechanism includes a lever mechanism having a Clevis mechanism. The pilot terminal is configured to facilitate coupling of the first connector and the second connector.

In accordance with another aspect of the present technique, a connector assembly is presented. The assembly includes a first connector including a pilot terminal and a plurality of first terminals. Further, the assembly includes a second connector including a cavity and a plurality of second terminals, where the plurality of second terminals is configured to mate with the plurality of first terminals. In addition, the assembly includes a lever assembly including a lever and having a first end and a second end, where the first end of the lever is configured to pull the pilot terminal of the first connector through the cavity of the second connector to facilitate coupling the first connector and the second connector.

In accordance with another aspect of the present technique, a method of releasably coupling a first connector and a second connector in a connector assembly is presented. The method includes releasably coupling the first connector having a pilot terminal and a plurality of first terminals with a second connector having a plurality of second terminals via a coupling mechanism, where the coupling mechanism includes a lever mechanism having a Clevis mechanism and is in operative association with a second connector.

In accordance with further aspects of the present technique a system for imaging is presented. The system includes an acquisition subsystem configured to acquire image data, where the acquisition subsystem includes a connector assembly. The connector assembly includes a first connector including a pilot terminal and a plurality of first terminals, a second connector including a plurality of second terminals, where the second connector is configured to be releasably coupled with the first connector, a housing disposed about the second connector and in operative association with the second connector, and a coupling mechanism in operative association with the second connector. The coupling mechanism is configured to aid in coupling the first connector and the second connector with use of a first force, and where the coupling mechanism includes a lever mechanism having a Clevis mechanism. Moreover, the system includes a processing subsystem in operative association with the acquisition subsystem and configured to process the acquired image data.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary diagnostic system, in accordance with aspects of the present technique;

FIG. 2 is a block diagram illustrating an embodiment of an imaging system for use in the diagnostic system of FIG. 1, in accordance with aspects of the present technique;

FIG. 3 is a side view illustrating an exemplary connector assembly for use in the system of FIGS. 1-2, in accordance with aspects of the present technique;

FIG. 4 is a perspective view of the exemplary connector assembly of FIG. 3, in accordance with aspects of the present technique

FIG. 5 is a perspective view of the exemplary connector assembly of FIG. 3 without a housing, in accordance with aspects of the present technique;

FIG. 6 is a diagrammatic illustration of an exemplary male connector for use in the connector assembly of FIG. 3, in accordance with aspects of the present technique;

FIG. 7 is a perspective view of an exemplary female connector for use in the connector assembly of FIG. 3, in accordance with aspects of the present technique;

FIG. 8 is a diagrammatic illustration of a coupling mechanism for use in the connector assembly of FIG. 3, in accordance with aspects of the present technique;

FIG. 9 is a side view of FIG. 7 illustrating the female connector and the coupling mechanism for use in the connector assembly of FIG. 3, in accordance with aspects of the present technique;

FIG. 10 is a diagrammatic illustration of an exemplary process of engaging and/or disengaging a male connector and a female connector in a connector assembly, in accordance with aspects of the present technique;

FIG. 11 is a diagrammatic illustration of an exemplary process of minimizing operator effort by adjusting lever lengths in a connector assembly, in accordance with aspects of the present technique;

FIG. 12 is a graphical representation of exemplary simulation results for variations of force with respect to time, in accordance with aspects of the present technique; and

FIGS. 13-14 are diagrammatic illustrations of other exemplary processes of engaging and/or disengaging a male connector and a female connector in a connector assembly, in accordance with aspects of the present technique.

### DETAILED DESCRIPTION

As will be described in detail hereinafter, a method for engaging and/or disengaging a male connector and a female connector in a connector assembly and a system configured to optimize and simplify the engaging and/or disengaging a male connector and a female connector in a connector assembly are presented. Employing the method and system described hereinafter, the male and female connectors in a connector assembly may be engaged and/or disengaged with a relatively small force, thereby reducing operator fatigue and enhancing operator comfort.

Although, the exemplary embodiments illustrated hereinafter are described in the context of a medical imaging system, it will be appreciated that use of the present connector assembly and system in industrial applications are also contemplated in conjunction with the present technique. For example, the embodiments of the present technique may be employed in modular equipment like radar stations, power connectors, control station connectors, to name a few.

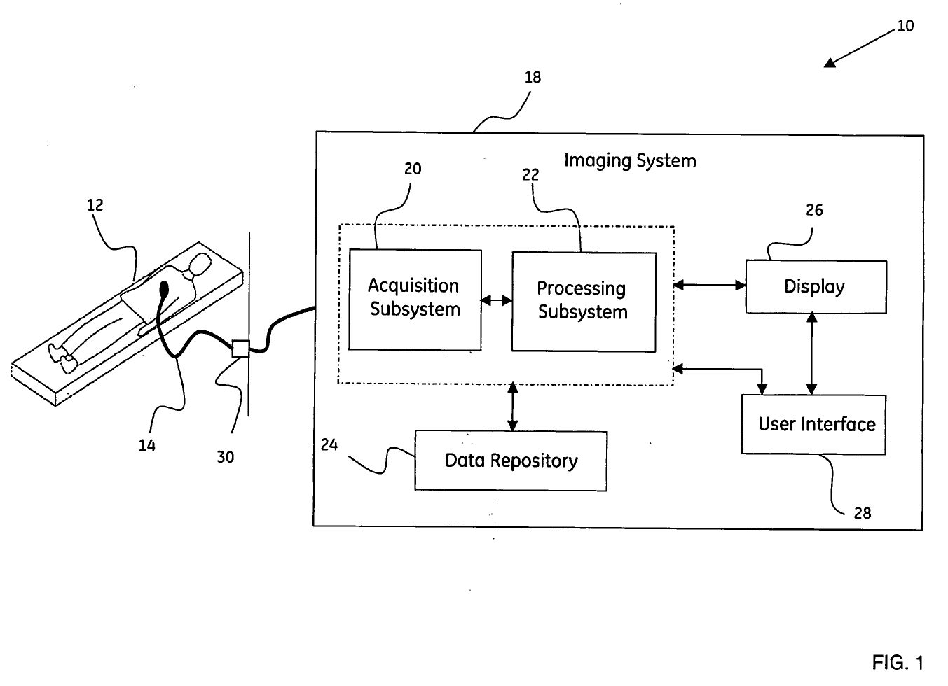

FIG. 1 is a block diagram of an exemplary system 10 for use in diagnostic imaging in accordance with aspects of the present technique. The system 10 may be configured to acquire image data from a patient 12 via an image acquisition device 14. In one embodiment, the image acquisition device 14 may include a probe, where the probe may include an invasive probe, or a non-invasive or external probe, such as an external ultrasound probe, that is configured to aid in the acquisition of image data. Also, in certain other embodiments, image data may be acquired via one or more sensors (not shown) that may be disposed on the patient 12. By way of example, the sensors may include physiological sensors (not shown) such as electrocardiogram (ECG) sensors and/or positional sensors such as electromagnetic field sensors or inertial sensors. These sensors may be operationally coupled to a data acquisition device, such as an imaging system, via leads (not shown), for example.

The system 10 may also include an imaging system 18 that is in operative association with the image acquisition device 14. In a presently contemplated configuration, the imaging system 18 may include a medical imaging system. It may be noted that although the present example illustrates the diagnostic system 10 as including one imaging system 18, the diagnostic system 10 may include more than one imaging system.

It should be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ ultrasound imaging in conjunction with other imaging modalities, position-tracking systems or other sensor systems. Furthermore, it should be noted that although the exemplary embodiments illustrated hereinafter are described in the context of a medical imaging system, such as, but not limited to, an ultrasound imaging system, an optical imaging system, a computed tomography (CT) imaging system, a magnetic resonance (MR) imaging system, an X-ray imaging system, or a positron emission tomography (PET) imaging system, or combinations thereof, other imaging systems, such as, but not limited to, a pipeline inspection system, a liquid reactor inspection system, a manufacturing inspection system, or other imaging systems are also contemplated in accordance with aspects of the present technique.

In a presently contemplated configuration, the medical imaging system 18 may include an acquisition subsystem 20 and a processing subsystem 22. Further, the acquisition subsystem 20 of the medical imaging system 18 may be configured to acquire image data representative of one or more anatomical regions of interest in the patient 12 via the probe 14. The image data acquired from the patient 12 may then be processed by the processing subsystem 22.

Additionally, the image data acquired and/or processed by the medical imaging system 18 may be employed to aid the clinician in identifying disease states, assessing need for treatment, determining suitable treatment options, and/or monitoring the effect of treatment on the disease states. It may be noted that the terms treatment and therapy may be used interchangeably. In certain embodiments, the processing subsystem 22 may be further coupled to a storage system, such as a data repository 24, where the data repository is configured to receive image data.

As illustrated in FIG. 1, the medical imaging system 18 may include a display 26 and a user interface 28. However, in certain embodiments, such as in a touch screen, the display 26 and the user interface 28 may overlap. Also, in some embodiments, the display 26 and the user interface 28 may include a common area. In accordance with aspects of the present technique, the display 26 of the medical imaging system 18 may be configured to display an image generated by the medical imaging system 18 based on the image data acquired via the probe 14. Additionally, the display 26 may be configured to aid the user in defining and visualizing image acquisition. It should be noted that the display 26 may include a three-dimensional display. In one embodiment, the three-dimensional display may be configured to aid in identifying and visualizing three-dimensional shapes.

Further, the user interface 28 of the medical imaging system 18 may include a human interface device (not shown) configured to facilitate the user in organizing and manipulating image data displayed on the display 26. The human interface device may include a mouse-type device, a trackball, a joystick, a stylus, or a touch screen configured to facilitate the user to identify the one or more regions of interest requiring therapy. However, as will be appreciated, other human interface devices, such as, but not limited to, a touch screen, may also be employed.

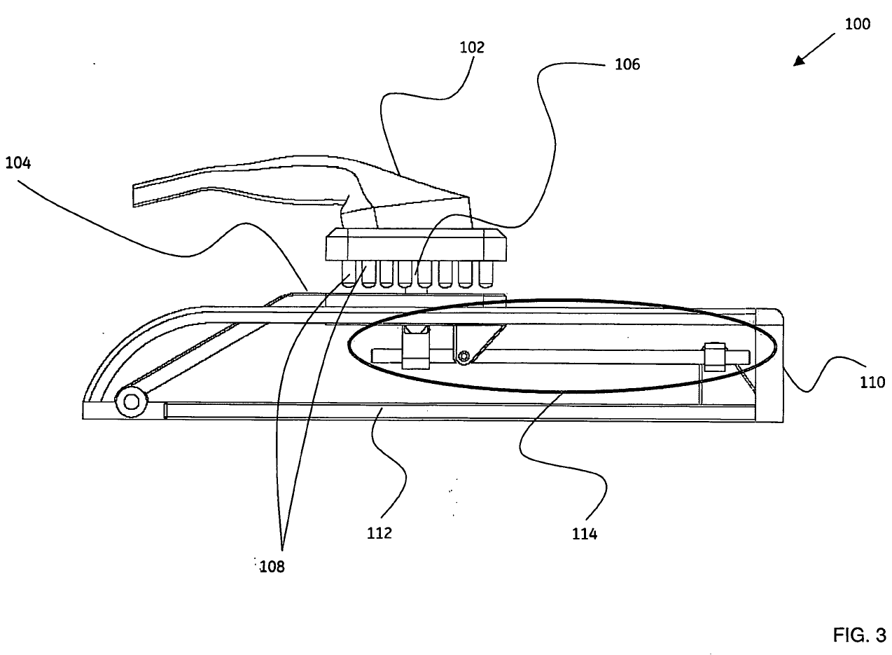

With continuing reference to FIG. 1, the image acquisition device 14 may be operationally coupled with the imaging system 18 via an exemplary connector assembly 30. In one embodiment, the connector assembly 30 may include a first connector (not shown in FIG. 1) and a second connector (not shown in FIG. 1). The exemplary connector assembly 30 may be configured to releasably couple the first and second connectors via a lever mechanism (not shown in FIG. 1), where the lever mechanism includes a Clevis mechanism (not shown in FIG. 1). The operation of the connector assembly 30 will be described in greater detail with reference to FIGS. 3-14.

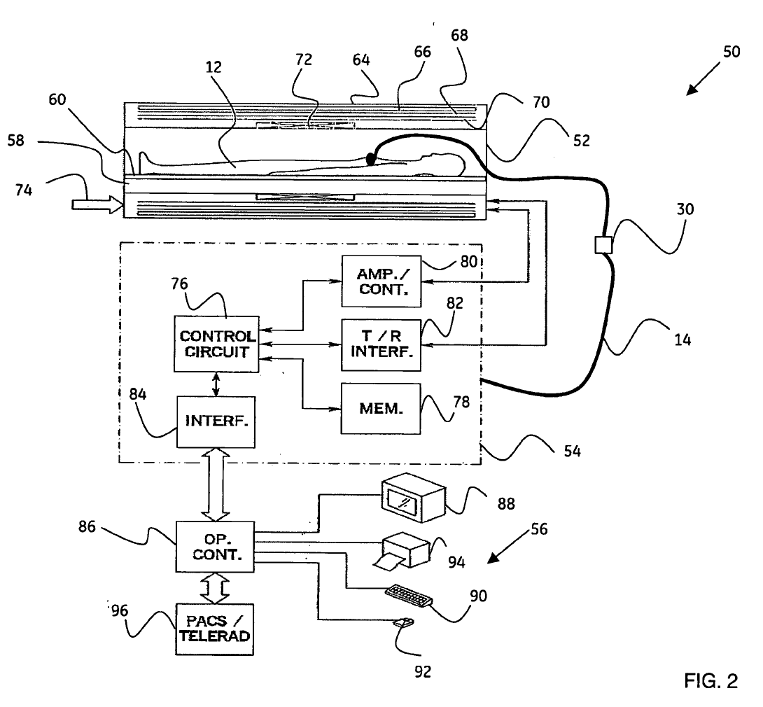

As previously noted with reference to FIG. 1, the medical imaging system 18 may include a magnetic resonance imaging (MRI) imaging system. FIG. 2 is a block diagram of an embodiment of an MRI imaging system 50 depicted in FIG. 1. The MRI system 50 is illustrated diagrammatically as including a scanner 52, scanner control circuitry 54, and system control circuitry 56. While the MRI system 50 may include any suitable MRI scanner or detector, in the illustrated embodiment the system includes a full body scanner including a patient bore 58 into which a table 60 may be positioned to place the patient 12 in a desired position for scanning. The scanner 52 may be of any suitable type of rating, including scanners varying from 0.5 Tesla ratings to 1.5 Tesla ratings and beyond.

Additionally, the scanner 52 may include a series of associated coils for producing controlled magnetic fields, for generating radio-frequency (RF) excitation pulses, and for detecting emissions from gyromagnetic material within the patient 12 in response to such pulses. In the diagrammatical view of FIG. 2, a primary magnet coil 64 may be provided for generating a primary magnetic field generally aligned with patient bore 58. A series of gradient coils 66, 68 and 70 may be grouped in a coil assembly for generating controlled magnetic gradient fields during examination sequences as will be described in greater detail hereinafter. A RF coil 72 may be provided for generating radio frequency pulses for exciting the gyromagnetic material. In the embodiment illustrated in FIG. 2, the coil 72 also serves as a receiving coil. Thus, the RF coil 72 may be coupled with driving and receiving circuitry in passive and active modes for receiving emissions from the gyromagnetic material and for applying RF excitation pulses, respectively. Alternatively, various configurations of receiving coils may be provided separate from the RF coil 72. Such coils may include structures specifically adapted for target anatomies, such as head coil assemblies, and so forth. Moreover, receiving coils may be provided in any suitable physical configuration, including phased array coils, and so forth.

In a presently contemplated configuration, the gradient coils 66, 68 and 70 may have different physical configurations adapted to their function in the imaging system 50. As will be appreciated by those skilled in the art, the coils include conductive wires, bars or plates that are wound or cut to form a coil structure that generates a gradient field upon application of control pulses as described below. The placement of the coils within the gradient coil assembly may be done in several different orders. In one embodiment, a Z-axis coil may be positioned at an innermost location, and may be formed generally as a solenoid-like structure that has relatively little impact on the RF magnetic field. Thus, in the illustrated embodiment, gradient coil 70 is the Z-axis solenoid coil, while coils 66 and 68 are Y-axis and X-axis coils respectively.

The coils of the scanner 52 may be controlled by external circuitry to generate desired fields and pulses, and to read signals from the gyromagnetic material in a controlled manner. As will be appreciated by those skilled in the art, when the material, typically bound in tissues of the patient, is subjected to the primary field, individual magnetic moments of the paramagnetic nuclei in the tissue partially align with the field. While a net magnetic moment is produced in the direction of the polarizing field, the randomly oriented components of the moment in a perpendicular plane generally cancel one another. During an examination sequence, an RF frequency pulse is generated at or near the Larmor frequency of the material of interest, resulting in rotation of the net aligned moment to produce a net transverse magnetic moment. This transverse magnetic moment precesses around the main magnetic field direction, emitting RF signals that are detected by the scanner 52 and processed for reconstruction of the desired image.

The gradient coils 66, 68 and 70 may be configured to serve to generate precisely controlled magnetic fields, the strength of which vary over a predefined field of view, typically with positive and negative polarity. When each coil is energized with known electric current, the resulting magnetic field gradient is superimposed over the primary field and produces a desirably linear variation in the Z-axis component of the magnetic field strength across the field of view. The field varies linearly in one direction, but is homogenous in the other two. The three coils have mutually orthogonal axes for the direction of their variation, enabling a linear field gradient to be imposed in an arbitrary direction with an appropriate combination of the three gradient coils.

The pulsed gradient fields perform various functions integral to the imaging process. Some of these functions are slice selection, frequency encoding and phase encoding. These functions may be applied along the X-axis, Y-axis and Z-axis of the original coordinate system or along other axes determined by combinations of pulsed currents applied to the individual field coils.

The slice select gradient determines a slab of tissue or anatomy to be imaged in the patient. The slice select gradient field may be applied simultaneously with a frequency selective RF pulse to excite a known volume of spins within a desired slice that precess at the same frequency. The slice thickness is determined by the bandwidth of the RF pulse and the gradient strength across the field of view.

The frequency encoding gradient is also known as the readout gradient, and is usually applied in a direction perpendicular to the slice select gradient. In general, the frequency encoding gradient is applied before and during the formation of the magnetic resonance (MR) echo signal resulting from the RF excitation. Spins of the gyromagnetic material under the influence of this gradient are frequency encoded according to their spatial position along the gradient field. By Fourier transformation, acquired signals may be analyzed to identify their location in the selected slice by virtue of the frequency encoding.

Finally, the phase encode gradient is generally applied before the readout gradient and after the slice select gradient. Localization of spins in the gyromagnetic material in the phase encode direction may be accomplished by sequentially inducing variations in phase of the precessing protons of the material using slightly different gradient amplitudes that are sequentially applied during the data acquisition sequence. The phase encode gradient permits phase differences to be created among the spins of the material in accordance with their position in the phase encode direction.

As will be appreciated by those skilled in the art, a great number of variations may be devised for pulse sequences employing the exemplary gradient pulse functions described hereinabove as well as other gradient pulse functions not explicitly described here. Moreover, adaptations in the pulse sequences may be made to appropriately orient both the selected slice and the frequency and phase encoding to excite the desired material and to acquire resulting MR signals for processing.

The coils of the scanner 52 are controlled by scanner control circuitry 54 to generate the desired magnetic field and RF pulses. In the diagrammatical view of FIG. 2, the control circuitry 54 thus includes a control circuit 76 for commanding the pulse sequences employed during the examinations, and for processing received signals. The control circuit 76 may include any suitable programmable logic device, such as a CPU or digital signal processor of a general purpose or application-specific computer. Also, the control circuit 76 may further include memory circuitry 78, such as volatile and non-volatile memory devices for storing physical and logical axis configuration parameters, examination pulse sequence descriptions, acquired image data, programming routines, and so forth, used during the examination sequences implemented by the scanner.

Interface between the control circuit 76 and the coils of the scanner 52 is managed by amplification and control circuitry 80 and by transmission and receive interface circuitry 82. The amplification and control circuitry 80 includes amplifiers for each gradient field coil to supply drive current to the field coils in response to control signals from control circuit 76. Transmit/receive (T/R) circuitry 82 includes additional amplification circuitry for driving the RF coil 72. Moreover, where the RF coil 72 serves both to emit the RF excitation pulses and to receive MR signals, the T/R circuitry 82 may typically include a switching device for toggling the RF coil between active or transmitting mode, and passive or receiving mode. A power supply, denoted generally by reference numeral 74 in FIG. 2, is provided for energizing the primary magnet 64. Finally, the range control circuitry 54 may include interface components 84 for exchanging configuration and image data with system control circuitry 56. It should be noted that, while in the present description reference is made to a horizontal cylindrical bore imaging system employing a superconducting primary field magnet assembly, the present technique may be applied to various other configurations, such as scanners employing vertical fields generated by superconducting magnets, permanent magnets, electromagnets or combinations of these means.

The system control circuitry 56 may include a wide range of devices for facilitating interface between an operator or radiologist and the scanner 52 via the scanner control circuitry 54. In the illustrated embodiment, for example, an operator controller 86 is provided in the form of a computer workstation employing a general purpose or application-specific computer. The workstation also typically includes memory circuitry for storing examination pulse sequence descriptions, examination protocols, user and patient data, image data, both raw and processed, and so forth. Further, the workstation may further include various interface and peripheral drivers for receiving and exchanging data with local and remote devices. In the illustrated embodiment, such devices include a conventional computer keyboard 90 and an alternative input device such as a mouse 92. A printer 94 may be provided for generating hard copy output of documents and images reconstructed from the acquired data. Moreover, a computer monitor 88 may be provided for facilitating operator interface. In addition, the system 50 may include various local and remote image access and examination control devices, represented generally by reference numeral 96 in FIG. 2. Such devices may include picture archiving and communication systems, teleradiology systems, and the like.

As previously noted, there is a need for a connector assembly for engaging and/or disengaging the connectors in a connector assembly that may be configured to aid in meeting the higher force requirements for engaging and/or disengaging the connectors, while maintaining the force necessary below regulatory requirements. Furthermore, there is also a need for a connecter assembly, which may facilitate a single step operation for the ergonomic ease of operation.

Accordingly, an exemplary connector assembly is presented. Referring now to FIG. 3, a perspective view 100 of a connector assembly, such as connector assembly 30 (see FIG. 1 or 2), configured for use in the system 10 (see FIG. 1) is illustrated. It may be noted that, although the embodiments illustrated are described in the context of an MRI system, other types of imaging systems such as an ultrasound imaging system, an X-ray imaging system, a nuclear imaging system, a positron emission tomography (PET) system, or combinations thereof, are also contemplated in conjunction with the present technique. The connector assembly 100 may include a first connector 102 and a second connector 104. In one embodiment, the first connector 102 may include a male connector, while the second connector 104 may include a female connector configured to be releasably coupled with the male connector 102.

It may be noted that the terms first connector and male connector may be used interchangeably. Also, the terms second connector and female connector may be used interchangeably. Furthermore, the terms coupling and engaging may be used interchangeably, while the terms uncoupling and disengaging may be used interchangeably.

In accordance with exemplary aspects of the present technique, the first connector 102 may be configured to include a pilot terminal 106 and a plurality of first terminals 108. The exemplary pilot terminal 106 may be configured to aid in coupling the first connector 102 with the second connector 104 with use of a substantially small force and will be described in greater detail hereinafter. This force may include a coupling force configured to aid in releasably engaging the first connector and the second connector. Additionally, the second connector 104 is configured to include a plurality of second terminals (not shown in FIG. 3), where the plurality of second terminals may be configured to be releasably coupled with the plurality of first terminals 108. Additionally, the connector assembly 100 may include a housing 110 disposed about the second connector 104. The housing 110 is operatively coupled to the second connector 104. In certain embodiments, the housing 110 may include a base plate 112.

Furthermore, according to exemplary aspects of the present technique, the connector assembly 100 may also include a coupling mechanism 114 configured to aid in engaging and/or disengaging the first connector 102 and the second connector 104. The coupling mechanism 114 may be operatively coupled to the second connector 104 and the housing 110, in one embodiment. Furthermore, in a presently contemplated configuration, the coupling mechanism 114 may include a lever mechanism. More particularly, the coupling mechanism may include a Clevis and Slider lever mechanism.

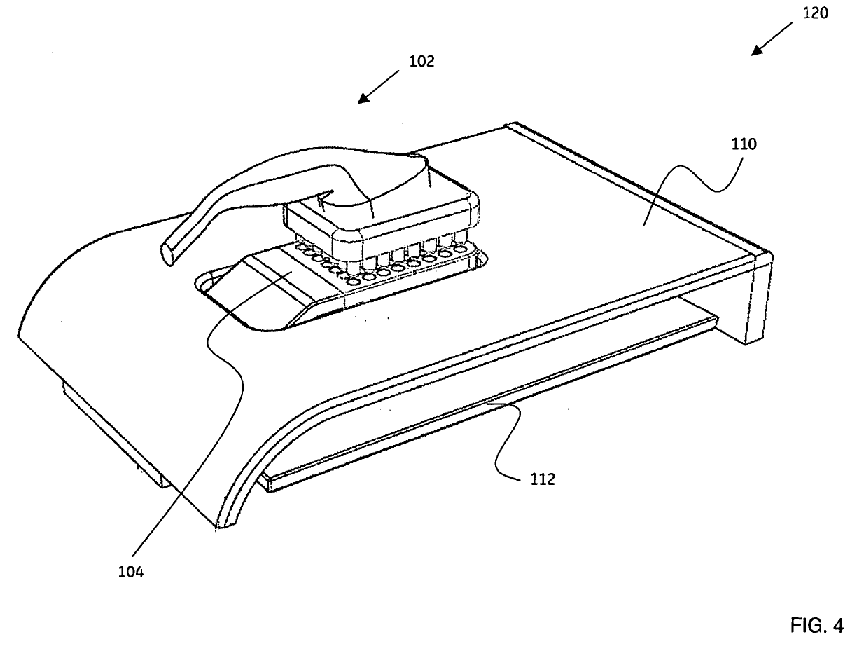

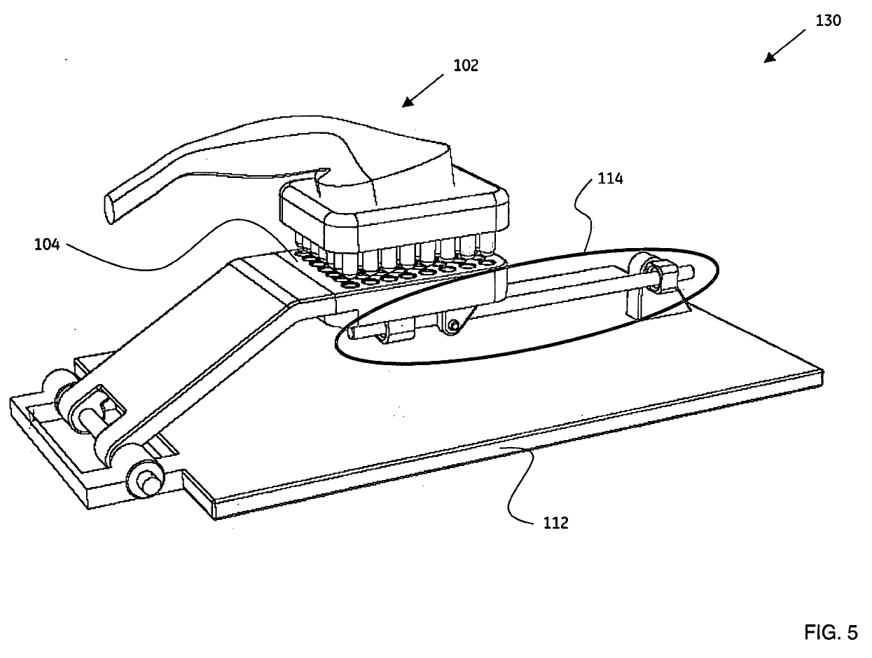

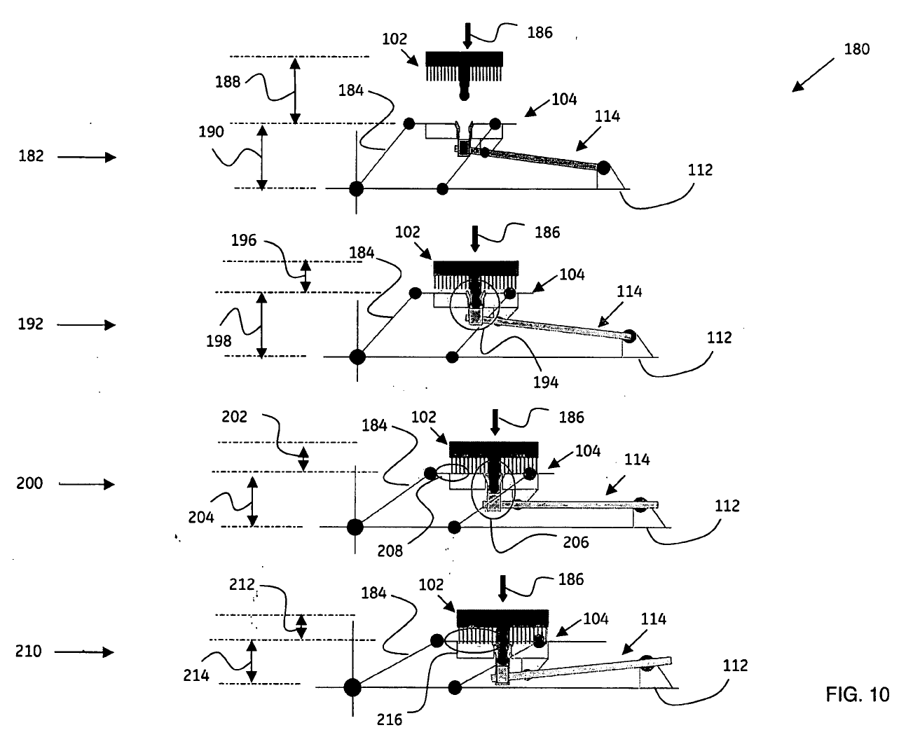

FIG. 4 depicts a perspective view 120 of the connector assembly 100 illustrated in FIG. 3. Further, a perspective view 130 of the connector assembly 100 (see FIG. 3) without the housing 110 is illustrated in FIG. 5. The operation of the connector assembly 100 will be described in greater detail with respect to FIGS. 10-14.

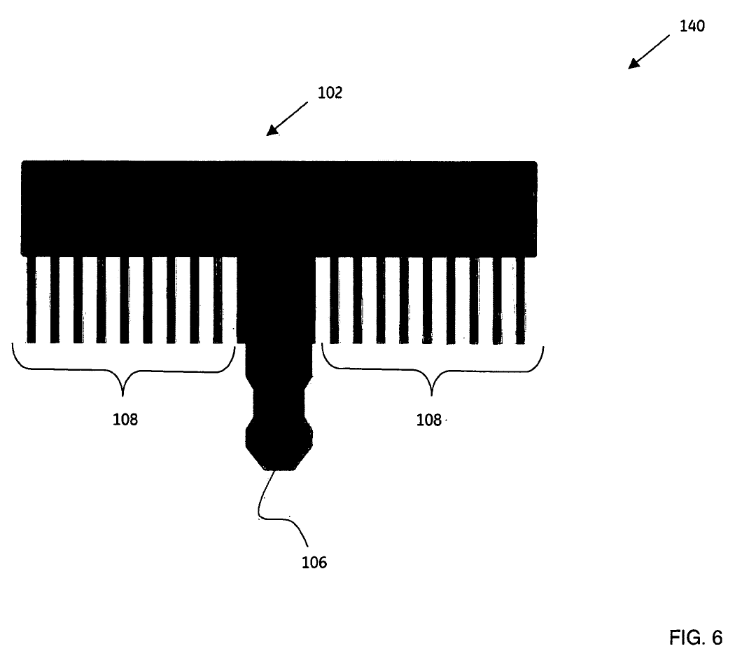

Turning now to FIG. 6, a diagrammatic illustration 140 of the male connector 102 (see FIG. 3) is depicted. The exemplary male connector 102 illustrated in FIG. 3 may be configured to facilitate engaging and/or disengaging the male connector 102 with a corresponding female connector while using a substantially small coupling force. The male connector 102 is shown as including the plurality of first terminals 108 and the pilot terminal 106. Furthermore, as previously noted, the pilot terminal 106 and the plurality of first terminals 108 are configured to aid in engaging and/or disengaging the male connector 102 with a female connector, such as female connector 104 (see FIG. 3). The operation of the male connector 102 will be described in greater detail with reference to FIGS. 10-14.

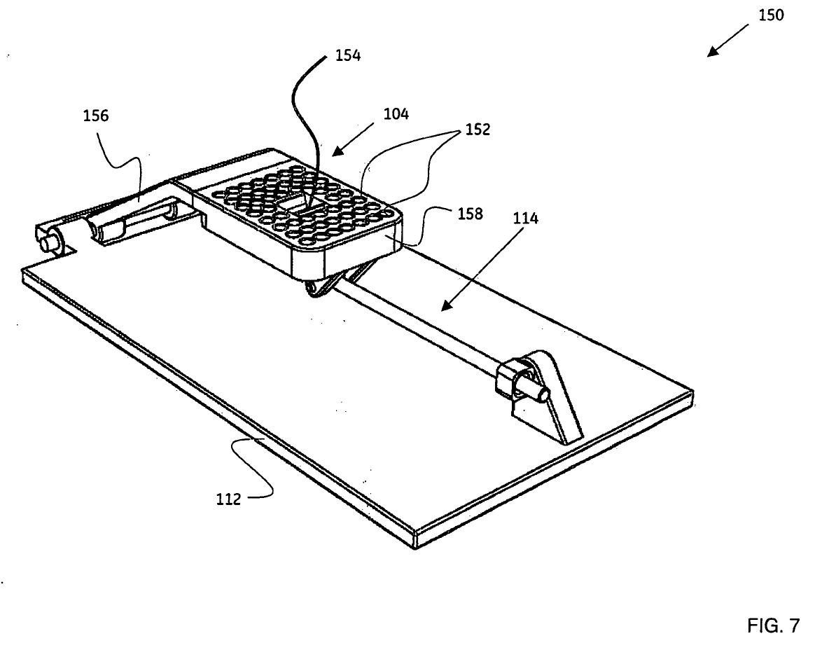

FIG. 7 depicts a perspective view 150 of the female connector 104 (see FIG. 3). The female connector 150 may be configured to include a plurality of second terminals 152, where the plurality of second terminals 152 is configured to be mateably engaged and/or disengaged with the plurality of first terminals 108 (see FIG. 6) in the male connector (see FIG. 6). Additionally, the female connector 104 may also be configured to include a cavity 154. The cavity 154 may be configured to allow passage of the pilot terminal 106 (see FIG. 6) and the lever mechanism 114 (see FIG. 3), thereby facilitating the engagement and/or disengagement of the male connector 102 (see FIG. 6) and the female connector 104.

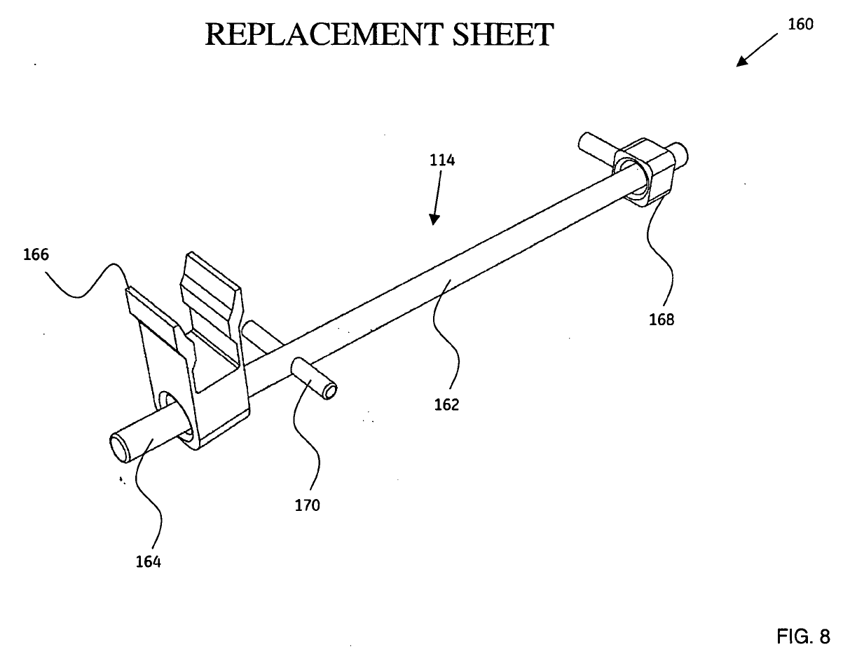

In addition, the female connector 104 may also include a first end 156 and a second end 158. Further, in a presently contemplated configuration, the first end 156 of the female connector 104 may be operatively coupled to the housing 110 (see FIG. 3). More particularly, the first end 156 of the female connector 104 may be coupled to the base plate 112 of the housing 110. In a similar fashion, the second end 158 of the female connector 104 may be in operative association with the lever mechanism 114. In particular, the second end 158 of the female connector 104 may be in operative association with a fulcrum portion of the lever mechanism 114. Also depicted in FIG. 7 is the lever mechanism 114 and will be described in greater detail with reference to FIG. 8.

Turning now to FIG. 8, a perspective view 160 of an exemplary coupling mechanism configured for use in the connector assembly 100 (see FIG. 3) is illustrated. The coupling mechanism 160 may be configured to aid in engaging and/or disengaging the male connector 102 (see FIG. 3) and the female connector 104 (see FIG. 3). In a presently contemplated configuration, the coupling mechanism 160 may include a lever mechanism, such as the lever mechanism 114 (see FIG. 3). More particularly, the lever mechanism 114 may include a Clevis and Slider mechanism. As depicted in FIG. 8, the lever mechanism 114 may include a lever 162, a working portion 164, a fixed portion 168 and a fulcrum portion 170. Further, in accordance with exemplary aspects of the present technique, the working portion 164 may include a Clevis mechanism 166 disposed thereon, where the Clevis mechanism 166 may be configured to aid in engaging and/or disengaging the male connector 102 (see FIG. 3) with the female connector 104 (see FIG. 3). More particularly, the Clevis mechanism 166 may be configured to engage and/or disengage with the pilot terminal 106 (see FIG. 6) of the male connector 102. Furthermore, the working portion 164 including the Clevis mechanism 166 may be configured to pass through the cavity 154 (see FIG. 7) in the female connector 104.

In addition, the fixed portion 168 of the lever mechanism 114 may be operationally coupled to the housing 110 (see FIG. 3). In one embodiment, the fixed portion 168 may be coupled to the base plate 112 (see FIG. 3). Moreover, the fulcrum portion 170 of the lever mechanism 114 may be configured to facilitate operatively coupling the second end 158 of the female connector 104 with the lever mechanism 114. The operation of the lever mechanism 114 will be described in greater detail with reference to FIGS. 10-14.

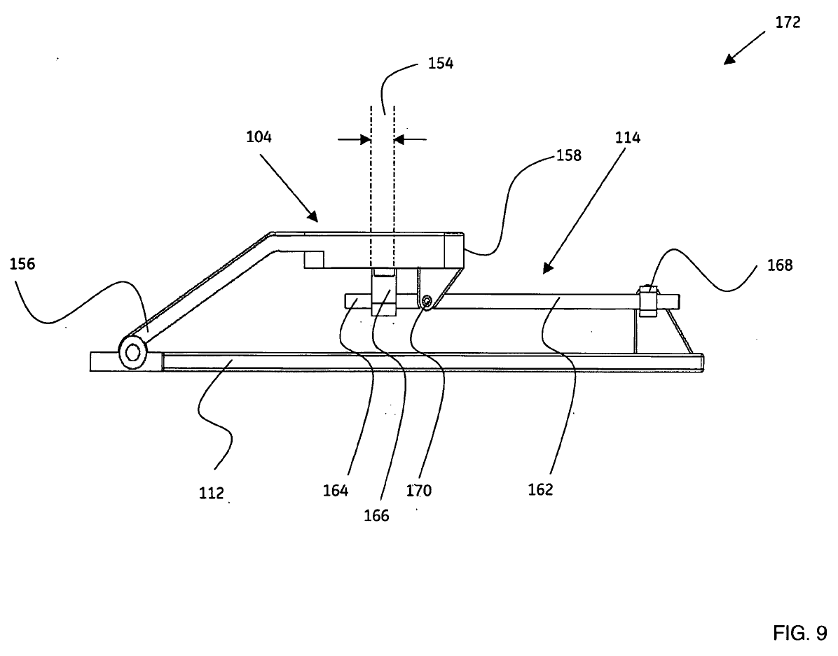

Referring now to FIG. 9, a side view 172 of the female connector 104 (see FIG. 7) and the lever mechanism 114 (see FIG. 8) is illustrated. As previously noted, the first end 156 of the female connector 104 is operatively coupled to the base plate 112, while the second end 158 of the female connector 104 is in operative association with the fulcrum portion 170 of the lever mechanism 114. Additionally, the fixed portion 168 of the lever mechanism 114 is also coupled to the base plate 112. Furthermore, the working portion 164 of the lever mechanism 114 is configured to pass through the cavity 154 in the female connector 104. More particularly, the Clevis mechanism 166 is configured to pass through the cavity 154.

By implementing the connector assembly as described with reference to FIGS. 3-9, the male connector 102 and the female connector 104 in the connector assembly 100 may be coupled and/or uncoupled with use of a substantially reduced coupling and/or uncoupling force. As previously noted, the increase in the number of connector pins disadvantageously results in a dramatic increase in the force required to couple and/or uncouple the connectors in a connector assembly and may exceed the recommended operator force limits.

For example, in a conventional connector assembly, for an input force in a range from about 10 kgf to about 12 kgf exerted by the clinician, an output force in a range from about 10 kgf to about 12 kgf may be obtained. However, employing the exemplary connector assembly 100 illustrated in FIG. 3, for an input force in a range from about 10 kgf to about 12 kgf exerted by the clinician, an output force in a range from about 70 kgf to about 80 kgf may be obtained. As previously noted, the output force is dependent upon the length of the lever 162.

As previously described, across the various imaging modalities, such as, but not limited to, MR, CT, ultrasound, or X-ray, there exists a need for faster and higher resolution, thereby resulting in an increased number of channels. This increase in the number of channels has in turn resulted in an increase in the number of connector pins. Consequently, an effort exerted by the operator to engage and/or disengage these connectors is disadvantageously high as a force needed to engage and/or disengage these connectors is directly proportional to this increase in the number of connector pins. Furthermore, this increase in the number of connector pins also may result in exceeding the mandated force limit. Accordingly, an exemplary method of engaging and/or disengaging connectors in a connector assembly is presented, where the connector assembly is configured to facilitate engagement and/or disengagement of the connectors in the connector assembly with use of a substantially reduced push and/or pull force. The push force may be representative of a force applied in a first direction to engage the male and female connectors in a connector assembly, while a pull force may be indicative of a force applied in a second direction to disengage the male and female connectors. It may be noted that the second direction may be substantially opposite to the first direction. Also, the terms push force, engaging force, and coupling force may be used interchangeably, while the terms pull force, disengaging force, and uncoupling force may be used interchangeably.

Turning now to FIG. 10, a diagrammatic illustration 180 of an exemplary process of engaging and/or disengaging a male connector and a female connector in a connector assembly is depicted. As previously described with reference to FIGS. 3-9, the connector assembly 100 (see FIG. 3) includes a male connector 102, a female connector 104 and a lever mechanism 114 configured to facilitate coupling the male and female connectors 102, 104 with use of a substantially low force. As previously described, the second end 158 (see FIG. 7) of the female connector 104 is operationally coupled to the fulcrum portion 170 (see FIG. 8) of the lever mechanism 114, while the first end 156 (see FIG. 7) of the female connector 104 is in operative association with the base plate 112 (see FIG. 3) of the housing 110 (see FIG. 3). In the embodiment illustrated in FIG. 10, a mechanism configured to couple the second end 158 of the female connector 104 to the base plate 112 may include a parallel bar variant mechanism 184.

As will be appreciated, for a given connector assembly, such as the connector assembly 100 (see FIG. 3), a push force is desirable to enable coupling a male connector, such as the male connector 102 (see FIG. 3) with a female connector, such as the female connector 104 (see FIG. 3). Accordingly, it is desirable that an operator, for example, exerts a corresponding force to facilitate coupling the male connector 102 to the female connector 104. This force exerted by the operator may be referred to as a coupling force. Furthermore, the terms push force, coupling force and engaging force may be used interchangeably, as previously noted.

The method starts at step 182 where a coupling force 186 is applied by the operator to the male connector 102, where the coupling force 186 is be configured to aid in coupling the male connector 102 with the female connector 104. More particularly, the coupling force 186 may be configured to move the male connector 102 in a first direction towards the female connector 104. It may be noted that the first direction includes a direction that is substantially similar to the direction of the coupling force 186. Also, the male connector 102 includes the exemplary pilot terminal 106 (see FIG. 6) and the plurality of first terminals 108 (see FIG. 6), where the pilot terminal 106 is configured to aid in coupling the male connector 102 and the female connector 104, as previously noted. Furthermore, as depicted in FIG. 10, the Clevis mechanism 166 (see FIG. 8) disposed on the working portion 164 of the lever mechanism 114 is configured to pass through the cavity 154 (see FIG. 7) in the female connector 104. Additionally, the second end 158 (see FIG. 7) of the female connector 104 is operatively coupled to the fulcrum portion 170 of the lever mechanism 114, as previously noted. It may be noted that, at step 182, the male connector 102 is disposed at a distance x₁ 188 from the female connector 104. Also, the female connector 104 is disposed at a distance y₁ 190 from the base plate 112 of the housing 110, at step 182.

As noted with reference to step 182, consequent to the application of the coupling force 186, the male connector 102 is moved in the first direction towards the female connector 104. Further, with continued application of the coupling force 186, the pilot terminal 106 of the male connector may be moved in the first direction towards the female connector 104, as depicted in step 192. More particularly, the pilot terminal 106 may be moved in the first direction towards the Clevis mechanism 166 (see FIG. 8) of the lever mechanism 114. It may be noted that the Clevis mechanism 166 is presently positioned in the cavity 154 of the female connector 104. Moreover, with sustained application of the coupling force 186 in the first direction, the pilot terminal 106 may be maneuvered to make contact with the Clevis mechanism 166. In other words, as depicted in step 192, consequent to the continued application of the coupling force 186, the pilot terminal 106 may be configured to be positioned within the Clevis mechanism 166. Also, it may be noted that, at step 192, the male connector 102 is now disposed at a distance x₂ 196 from the female connector 104, where x₂ 196 is relatively less than x₁ 188. It may be noted that x₂<x₁ as the male connector 102 is disposed relatively closer to the female connector 104 due to the application of the coupling force 186. Moreover, at step 192, the female connector 104 is disposed at a distance y₂ 198 from the base plate 112 of the housing 110, where y₂ 198 is relatively less than y₁ 190. It may be noted that, in certain embodiments, y₂ 198 may be substantially equal to y₁ 190, as the parallel bar variant mechanism 184 or the female connector 104 may not be displaced from a corresponding position at step 182. Consequent to step 192, the pilot terminal 106 of the male connector 102 may be engaged with the Clevis mechanism 166 as indicated by reference numeral 194.

Subsequently, at step 200, with sustained application of the coupling force 186, the pilot terminal 106 of the male connector 102 may be configured to be locked with the Clevis mechanism 166 as depicted by reference numeral 206. Consequently, the male connector 102 may now be disposed adjacent to the female connector 104. In other words, at step 200, the male connector 102 is now disposed at a distance X₃ 202 from the female connector 104, where x₃ 202 is relatively less than x₂ 196. Furthermore, the plurality of first terminals 108 (see FIG. 6) of the male connector 102 may now be disposed such that plurality of first terminals 108 may be configured to make contact with a top surface of the female connector 104 as depicted by reference numeral 208.

As noted hereinabove, at step 200, the pilot terminal 106 of the male connector 102 is locked in the Clevis mechanism 166 of the lever mechanism 114. Consequently, with continued application of the coupling force 186, the Clevis mechanism 166 that is in operative association with the pilot terminal 106 may be configured to experience a downward movement in the first direction. More particularly, the Clevis mechanism 166 may be configured to move in the first direction in the cavity 154 of the female connector 104.

Consequent to the downward movement experienced by the Clevis mechanism 166 disposed on the working portion 164 of the lever mechanism 114, the fulcrum portion 170 (see FIG. 8) may also experience a corresponding downward movement. Accordingly, as the second end 158 (see FIG. 7) of the female connector 104 is coupled to the fulcrum portion 170 of the lever mechanism 114, the female connector 104 may also experience a downward movement substantially similar to the downward movement experienced by the fulcrum portion 170. Hence, at step 200, due to the downward movement experienced by the female connector 104, the female connector 104 may now be disposed at a distance y₃ 204 from the base plate 112, where y₃ 204 is substantially less than y₂ 198.

Following step 200, continual application of the coupling force 186 may be configured to move the Clevis mechanism 166 within the cavity 154 in the first direction towards the base plate 112, at step 210. More particularly, the working portion 164 of the lever mechanism 114 having the Clevis mechanism 166 disposed thereon may be configured to move towards the base plate 112 following the continued application of the coupling force 186. As a result, the male connector 104 may also be configured to experience a corresponding downward movement as the pilot terminal 106 is operatively coupled with the Clevis mechanism 166. Consequently, the male connector 102 may be pulled towards the female connector 104, thereby facilitating mating of the plurality of first terminals 108 with the corresponding plurality of second terminals 152 (see FIG. 7). It may be noted that the Clevis mechanism 166 that is disposed on the working portion 164 of the lever mechanism 114 may experience a relatively greater downward movement when compared to the downward movement experienced by the fulcrum portion 170 of the lever mechanism 114. Accordingly, the male connector 102 that is in operative association with the Clevis mechanism 166 is subject to a relatively greater downward movement, while the female connector 104 that is coupled to the fulcrum portion 170 experiences a relatively smaller downward movement. Reference numeral 212 is representative of a distance x₄ between the male connector 102 and the female connector 104 at step 210, where x₄ 212 is relatively less than x₃ 202. Similarly, a distance y₄ between the female connector 104 and the base plate 112 at step 210 is generally represented by reference numeral 214, where y₄ 214 is relatively less than y₃ 204.

Subsequently, as depicted by step 210, due to the continued application of the coupling force 186, the plurality of first terminals 108 in the male connector 102 is operatively coupled with the plurality of second terminals 152 in the female connector 104. This coupling is generally depicted by reference numeral 216. Furthermore, as will be appreciated, the Clevis mechanism 166 experiences a substantially greater displacement when compared to the displacement experienced by the fulcrum portion 170. Accordingly, the male connector 102 that is coupled with the Clevis mechanism 166 of the lever mechanism 114 experiences a substantially greater displacement when compared to the displacement experienced by the female connector 104. Hence, both the male connector 102 and the female connector 104 are configured to move in the direction of the coupling force 186, therefore facilitating coupling the male connector 102 and the female connector 104 with use of a substantially low coupling force.

Consequent to step 210, the male and female connectors 102, 104 are operationally coupled. In accordance with further aspects of the present technique, the male connector 102 may be disengaged from the female connector 104 by application of a disengaging force (not shown) in a second direction, where the second direction is substantially opposite the first direction of the coupling force 186. Here again, both the male connector 102 and the female connector 104 are configured to move in the direction of the disengaging force, therefore facilitating disengaging the male connector 102 from the female connector 104 with use of a substantially low disengaging force. It may be noted that the terms pull force, uncoupling force, and disengaging force may be used interchangeably, as previously noted.

By implementing the method as described hereinabove, the male and the female connectors 102, 104 may be coupled and/or uncoupled using a substantially reduced force, thereby advantageously minimizing operator fatigue. More particularly, use of the Clevis mechanism 166 disposed within the cavity 154 in the female connector 104 to facilitate the engagement and/or disengagement of the male and female connectors 102, 104 advantageously allows the operator to releasably couple and/or uncouple the male and female connectors 102, 104 with use of a substantially reduced force. Additionally, the method described hereinabove allows relatively easy mating of the plurality of first terminals 108 with the second set of terminals 152, thus avoiding any jamming of the terminals and/or damage of the terminals. Also, use of the parallel bar variant mechanism 184 facilitates substantially superior coupling between the male and female connectors 102, 104 as the male and female connectors 102, 104 remain parallel to the base plate 112 and therefore to the ground during both the engaging and disengaging of the male and female connectors 102, 104.

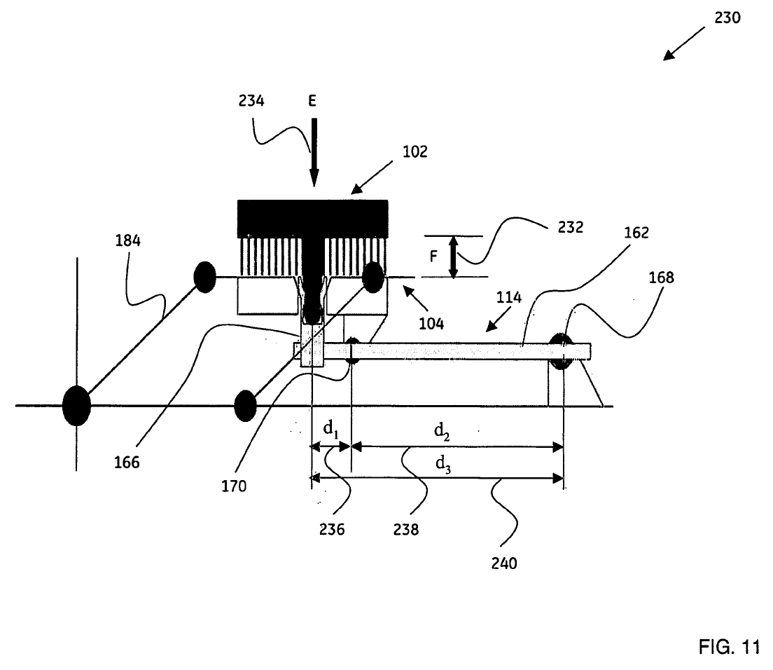

As noted hereinabove, the male and female connectors 102, 104 in the connector assembly 100 may be releasably coupled using a relatively small coupling and/or uncoupling force. In accordance with further aspects of the present technique, the effort expended by the operator to couple and/or uncouple the male and female connectors 102, 104 may be substantially minimized by adjusting the design of the lever 162 (see FIG. 8) of the lever mechanism 114 (see FIG. 8). In other words, according to exemplary aspects of the present technique, the design of the lever mechanism 114 may be adapted to meet desirable push force requirements, while maintaining the connector coupling force, such as coupling force 186, at a substantially constant value. This control of the design of the lever mechanism 114 may be better understood with reference to FIG. 11.

Turning now to FIG. 11, a diagrammatic illustration 230 of the exemplary connector assembly 100 (see FIG. 3) is illustrated. In the illustrated embodiment, reference numeral 232 is representative of a force F that is desirable for coupling a multi-pin male connector, such as the male connector 102 (see FIG. 3) with a female connector, such as the female connector 104 (see FIG. 3). Accordingly, a coupling force E, such as the coupling force 186 (see FIG. 10), may be applied by the operator, where the coupling force E may be configured to aid in coupling the male and female connectors 102, 104. The coupling force E 186 may be generally represented by reference numeral 234. Reference numeral 236 may be indicative of a distance d₁ between the Clevis mechanism 166 disposed on the working portion 164 of the lever mechanism 114 and the fulcrum portion 170, while a distance d₂ between the fulcrum portion 170 and the fixed portion 168 of the lever mechanism 114 may be generally represented by reference numeral 238. In a similar fashion, reference numeral 240 is representative of a distance d₃ between the Clevis mechanism 166 and the fixed portion 168 of the lever mechanism 114.

As noted hereinabove, the design of the lever mechanism 114 may be adapted to meet desirable force requirements F 232, while maintaining the connector coupling force E 234 at a substantially constant level. As will be appreciated, a gain in force is variable with position of stroke. In other words, the d₂/d₁ ratio determines the force gain obtained during the stroke. Accordingly, the d₂/d₁ ratio may be chosen such that the peak force is sufficient to couple the male and female connecters with a given coupling force E 234, where the coupling force E 234 is substantially constant and limited by human ability. Hence, in accordance with exemplary aspects of the present technique, an amplification factor D that is dependent upon the lever lengths d₁ 236, d₂ 238 and d₃ 240 may be introduced to facilitate achieving the desirable force F 232, while maintaining the coupling force E 234 at a substantially constant level. In accordance with exemplary aspects of the present technique, the desirable force F 232 may be achieved while using a relatively small coupling force E 234. In one embodiment, by adjusting the lever lengths d₁ 236, d₂ 238 and/or d₃ 240, the coupling of the male and female connectors 102, 104 may be achieved with use of the relatively small coupling force E 234, thereby advantageously reducing operator effort.

In other words, the lever lengths d₁ 236, d₂ 238 and d₃ 240 may be adjusted to obtain a desirable amplification factor. For example, as per design requirements, it may be desirable to use a force F 232 of about 48 kgf to couple the male and female connectors 102, 104 in the connector assembly 100. However, it may also be desirable to restrict the coupling force E 234 to have an upper limit of about 12 kgf. As will be appreciated, the coupling force E 234 applied by the operator may be a function of the force F 232. In one embodiment, the coupling force E 234 may be directly proportional to the push force F 232. In other words,

F∝E (1)

Furthermore, in one embodiment, using equation (1),

F=D×E (2)

where D is a transfer function representative of the amplification factor that is dependent upon the lever lengths d₁ 236, d₂ 238 and/or d₃ 240.

In one example, substituting

$$( \frac{{d}_{2}}{{d}_{1}} )$$

### for D:

$$F = ( \frac{{d}_{2}}{{d}_{1}} ) \times E \qquad ( 3 )$$

Further,

if

d₁=1X

and

d₂=4X, (4)

where X is a unit of length, then,

$$F = ( \frac{4 X}{1 X} ) \times 12 = 48 \text{kgf} . \qquad ( 5 )$$

Consequently, the desirable force F 232 of about 48 kgf may be achieved by using a relatively small coupling force E 234 of 12 kgf by adjusting the lever lengths. In a similar fashion, the male and female connectors 102, 104 may also be disengaged with use of a relatively small disengaging force.

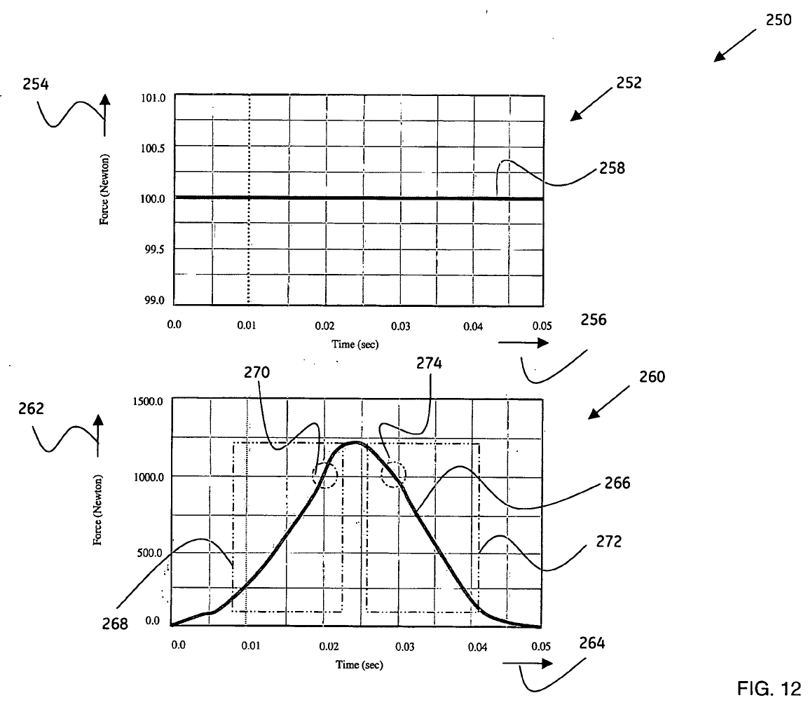

In FIG. 12, a graphical representation 250 of simulation results 252, 260 depicting a variation in an output force 266 as a function of an input force 258 is plotted against a variation in time 256. More particularly, reference numeral 252 is representative of simulation results depicting a variation in a force 254 plotted against a variation in time. Response curve 258 represents a variation of the force 254 as a function of the time 256 for the case where the force 254 is representative of a coupling force, such as the coupling force E 234 (see FIG. 11), applied by the operator. In the illustrated example, the coupling force 258 is shown as being substantially constant.

Also, reference numeral 260 is representative of simulation results depicting a variation in a force 262 plotted against a variation in time 264. Response curve 266 represents a variation of the force 262 as a function of the time 264 for the case where the force 266 is representative of a force experienced by the male and female connectors 102, 104 during the engaging and disengaging of the male and female connectors 102, 104. In addition, reference numeral 268 embodies a region of the output curve 266 representative of a gain experienced by the male and female connectors 102, 104 during the engaging operation. Similarly, a region of the output curve 266 indicative of a gain experienced by the male and female connectors 102, 104 during the disengaging operation may be generally represented by reference numeral 272. Moreover, reference numeral 270 embodies a region of optimum gain during the engagement of the male and female connectors 102, 104, while a region of optimum gain during the disengagement of the male and female connectors 102, 104 may be indicated by reference numeral 274. Accordingly, as may be seen from the simulation results 252, 260, maintaining the coupling force and/or uncoupling force exerted by the operator at a substantially constant value, an amplification in the output force experienced by the male and female connectors may be obtained, thereby enabling the engaging and/or disengaging of the male and female connectors102, 104 with use of a relatively small coupling and/or uncoupling force.

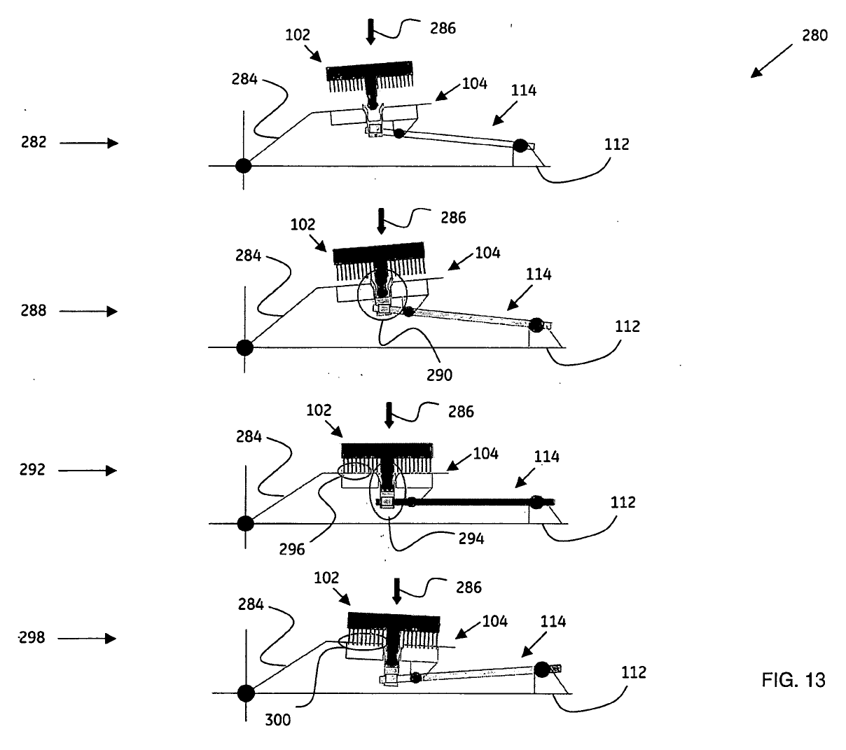

Turning now to FIG. 13, a diagrammatic illustration 280 of another exemplary process of engaging and/or disengaging a male connector and a female connector in a connector assembly is depicted. As previously described with reference to FIGS. 3-9, the connector assembly 100 (see FIG. 3) includes a male connector 102 (see FIG. 3), a female connector 104 (see FIG. 3) and a lever mechanism 114 (see FIG. 3) configured to facilitate coupling the male and female connectors 102, 104 with use of a substantially low force. In the embodiment illustrated in FIG. 13, the mechanism configured to couple the second end 158 (see FIG. 7) of the female connector 104 to the housing 110 (see FIG. 3) may include a hinged type variant mechanism 284.

As described with reference to FIG. 11, here again, the method starts at step 282 where a coupling force 286 may be applied by an operator to the male connector 102. The coupling force 286 is configured to aid in coupling the male connector 102 with the female connector 104. Here again, the coupling force 286 may be configured to move the male connector 102 in a first direction towards the female connector 104, where the first direction includes a direction that is substantially similar to the direction of the coupling force 286.

Furthermore, at step 282, consequent to the application of the coupling force 286, the male connector 102 is moved in the first direction towards the female connector 104. Moreover, with continued application of the coupling force 286, the pilot terminal 106 (see FIG. 6) of the male connector 102 may be moved in the first direction towards the female connector 104, as depicted in step 288. More particularly, the pilot terminal 106 may be moved in the first direction towards the Clevis mechanism 166 (see FIG. 8) of the lever mechanism 114. It may be noted that the Clevis mechanism 166 is presently positioned in the cavity 154 (see FIG. 7) of the female connector 104. With continued application of the coupling force 286 in the first direction, the pilot terminal 106 may be maneuvered to make contact with the Clevis mechanism 166. In other words, as depicted in step 288, consequent to the sustained application of the coupling force 286, the pilot terminal 106 may be configured to be positioned within the Clevis mechanism 166. Consequent to step 288, the pilot terminal 106 of the male connector 102 may be engaged with the Clevis mechanism 166 as indicated by reference numeral 290.

Subsequently, at step 292, with continual application of the coupling force 286, the pilot terminal 106 of the male connector 102 may be configured to be locked with the Clevis mechanism 166 as depicted by reference numeral 294. Consequently, the male connector 102 may now be disposed adjacent to the female connector 104. In other words, the plurality of first terminals 108 (see FIG. 6) of the male connector 102 may now be disposed such that plurality of first terminals 108 may be configured to make contact with a top surface of the female connector 104 as depicted by reference numeral 296.

As noted hereinabove, at step 292, the pilot terminal 106 of the male connector 102 is locked in the Clevis mechanism 166 of the lever mechanism 114. Here again, with continued application of the coupling force 286, the Clevis mechanism 166 that is in operative association with the pilot terminal 106 may be configured to experience a downward movement in the first direction. More particularly, the Clevis mechanism 166 may be configured to move in the first direction in the cavity 154 of the female connector 104.

As previously noted with reference to FIG. 10, consequent to the downward movement experienced by the Clevis mechanism 166 disposed on the working portion 164 of the lever mechanism 114, the fulcrum portion 170 (see FIG. 8) may also experience a corresponding downward movement. Also, as the second end 158 of the female connector 104 is coupled to the fulcrum portion 170 of the lever mechanism 114, the female connector 104 may also experience a downward movement substantially similar to the downward movement experienced by the fulcrum portion 170.

Following step 292, sustained application of the coupling force 286 may be configured to move the Clevis mechanism 166 in the first direction towards the base plate 112, at step 298. More particularly, the working portion 164 of the lever mechanism 114 having the Clevis mechanism 166 may be configured to move towards the base plate 112 following the continued application of the coupling force 286. As a result, the male connector 102 may also be configured to experience a corresponding downward movement as the pilot terminal 106 of the male connector 102 is coupled with the Clevis mechanism 166. Consequently, the male connector 102 may be pulled towards the female connector 104, thereby facilitating mating of the plurality of first terminals 108 with the corresponding plurality of second terminals 152 (see FIG. 7). Here again, the Clevis mechanism 166 that is disposed on the working portion 164 of the lever mechanism 114 may experience a relatively greater downward movement when compared to the downward movement experienced by the fulcrum portion 170 of the lever mechanism 114. Accordingly, the male connector 102 that is in operative association with the Clevis mechanism 166 is subject to a relatively greater downward movement, while the female connector 104 that is coupled to the fulcrum portion 170 experiences a relatively smaller downward movement.

Subsequently, as depicted by step 298, due to the continued application of the coupling force 286, the plurality of first terminals 108 in the male connector 102 is operatively coupled with the plurality of second terminals 152 in the female connector 104. This coupling is generally depicted by reference numeral 300. Furthermore, both the male connector 102 and the female connector 104 are configured to move in the direction of the coupling force 286, therefore facilitating coupling the male connector 102 and the female connector 104 with use of a substantially low coupling force.

Consequent to step 298, the male and female connectors 102, 104 are operationally coupled. In accordance with further aspects of the present technique, the male connector 102 may be disengaged from the female connector 104 by application of a disengaging force (not shown) in a second direction, where the second direction is substantially opposite the first direction of the coupling force 286. Here again, both the male connector 102 and the female connector 104 are configured to move in the direction of the disengaging force, therefore facilitating disengaging the male connector 102 from the female connector 104 with use of a substantially low disengaging force.

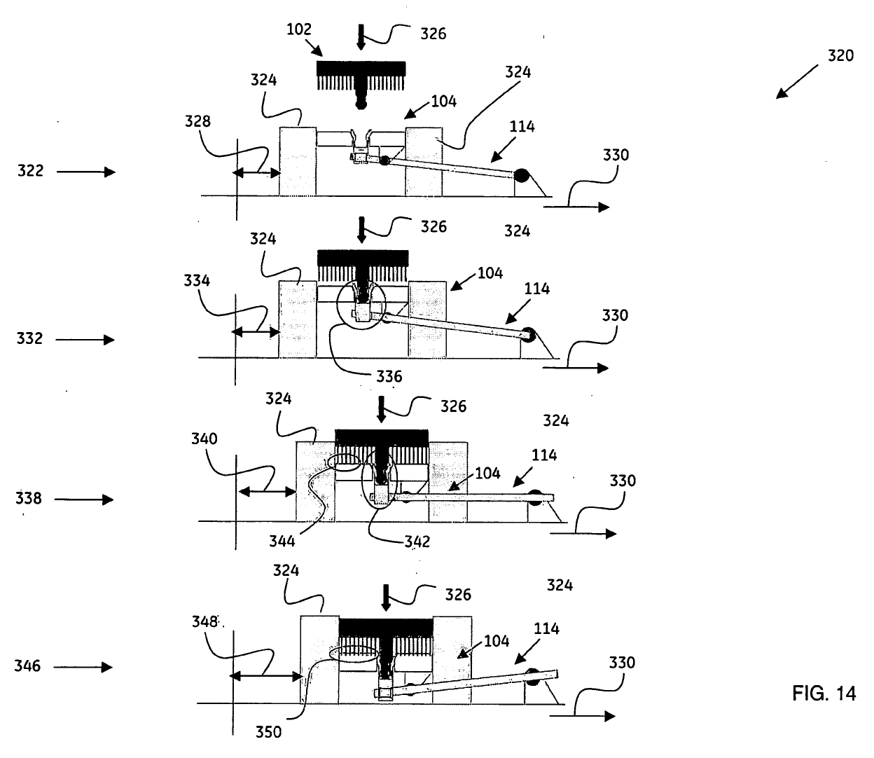

FIG. 14 is a diagrammatic illustration 320 of yet another exemplary process of engaging and/or disengaging a male connector and a female connector in a connector assembly is depicted. Further, in the embodiment illustrated in FIG. 14, the mechanism configured to couple the second end 158 (see FIG. 7) of the female connector 104 to the housing 110 (see FIG. 3) may include a sliding block variant mechanism 324.

As previously described with reference to FIG. 10, the method 320 starts at step 322 where a coupling force 326 is applied by an operator to the male connector 102. Here again, it may be noted that the coupling force 326 may be configured to move the male connector 102 in a first direction towards the female connector 104, where the first direction includes a direction that is substantially similar to the direction of the coupling force 326. Moreover, at step 322, consequent to the application of the coupling force 326, the male connector 102 is moved in the first direction towards the female connector 104. Also, a direction of movement of the sliding block mechanism 324 is generally depicted by reference numeral 330.

Further, with continued application of the coupling force 326, the pilot terminal 106 (see FIG. 6) of the male connector 102 may be moved in the first direction towards the female connector 104, as depicted in step 332. More particularly, the pilot terminal 106 may be moved in the first direction towards the Clevis mechanism 166 (see FIG. 8) of the lever mechanism 114. As previously noted, the Clevis mechanism 166 is presently positioned in the cavity 154 (see FIG. 7) of the female connector 104. With continual application of the coupling force 326 in the first direction, the pilot terminal 106 may be maneuvered to make contact with the Clevis mechanism 166. In other words, as depicted in step 332, due to the continued application of the coupling force 326, the pilot terminal 106 may be configured to be positioned within the Clevis mechanism 166. Consequent to step 332, the pilot terminal 106 of the male connector 102 may be engaged with the Clevis mechanism 166 as indicated by reference numeral 336.

Subsequently, at step 338, with sustained application of the coupling force 326, the pilot terminal 106 of the male connector 102 may be configured to be locked with the Clevis mechanism 166 as depicted by reference numeral 342. Consequently, the male connector 102 may now be disposed adjacent to the female connector 104. In other words, the plurality of first terminals 108 (see FIG. 6) of the male connector 102 may now be disposed such that plurality of first terminals 108 may be configured to make contact with a top surface of the female connector 104 as depicted by reference numeral 344.

As noted hereinabove, at step 338, the pilot terminal 106 of the male connector 102 is locked with the Clevis mechanism 166 of the lever mechanism 114. Consequently, with continued application of the coupling force 326, the Clevis mechanism 166 that is in operative association with the pilot terminal 106 may be configured to experience a downward movement in the first direction. More particularly, the Clevis mechanism 166 may be configured to move in the first direction in the cavity 154 of the female connector 104.

Here again, consequent to the downward movement experienced by the Clevis mechanism 166 disposed on the working portion 164 of the lever mechanism 114, the fulcrum portion 170 (see FIG. 8) may also experience a corresponding downward movement. Also, as the second end 158 of the female connector 104 is coupled to the fulcrum portion 170 of the lever mechanism 114, the female connector 104 may also experience a downward movement substantially similar to the downward movement experienced by the fulcrum portion 170.

Following step 338, sustained application of the coupling force 326 may be configured to move the Clevis mechanism 166 in the first direction towards the base plate 112, at step 346. More particularly, the working portion 164 of the lever mechanism 114 having the Clevis mechanism 166 may be configured to move towards the base plate 112 following the continued application of the coupling force 326. As a result, the male connector 102 may also be configured to experience a corresponding downward movement. Consequently, the male connector 102 may be pulled towards the female connector 104, thereby facilitating mating of the plurality of first terminals 108 with the corresponding plurality of second terminals 152 (see FIG. 7). Furthermore, as previously noted, the Clevis mechanism 166 that is disposed on the working portion 164 of the lever mechanism 114 may experience a relatively greater downward movement when compared to the downward movement experienced by the fulcrum portion 170 of the lever mechanism 114. Accordingly, the male connector 102 that is in operative association with the Clevis mechanism 166 is subject to a relatively greater downward movement, while the female connector 104 that is coupled to the fulcrum portion 170 experiences a relatively smaller downward movement.

Further, as depicted by step 346, due to the continued application of the coupling force 326, the plurality of first terminals 108 in the male connector 102 is operatively coupled with the plurality of second terminals 152 in the female connector 104. This coupling is generally depicted by reference numeral 350. Furthermore, both the male connector 102 and the female connector 104 are configured to move in the direction of the coupling force 326, therefore facilitating coupling the male connector 102 and the female connector 104 with use of a substantially low coupling force.

As previously described with reference to FIG. 10 and FIG. 13, consequent to step 346, the male and female connectors 102, 104 are operationally coupled. In accordance with further aspects of the present technique, the male connector 102 may be disengaged from the female connector 104 by application of a disengaging force (not shown) in a second direction, where the second direction is substantially opposite the first direction of the coupling force 326. Here again, both the male connector 102 and the female connector 104 are configured to move in the direction of the disengaging force, therefore facilitating disengaging the male connector 102 from the female connector 104 with use of a substantially low disengaging force.

The connector assembly, method of releasably coupling and/or uncoupling and the system for releasably coupling and/or uncoupling male and female connectors in a connector assembly described hereinabove dramatically reduce the force exerted by the operator to engage and/or disengage the male and female connectors in the connector assembly thereby enhancing speed of procedural time taken to perform imaging studies. Consequently, operator fatigue may be substantially minimized, while ergonomic comforts experienced by the operator may be enhanced. In addition, use of the connector assembly described hereinabove advantageously facilitates a single step operation of coupling and/or uncoupling the male and female connectors in the connector assembly, thereby eliminating the need to perform any secondary operations.

Furthermore, a connector having a relatively large number of connector pins/terminals may be coupled and/or decoupled with minimal operator effort, thereby advantageously facilitating the operator effort to lie within recommended ergonomic limits. Additionally, a relatively small engaging force and/or disengaging force may be employed to couple and/or uncouple the male and female connectors in the connector assembly. Moreover, the desirable push and/or pull forces may be achieved by adjusting the lever lengths, while maintaining the engaging and/or disengaging forces at a substantially constant value, thereby facilitating accommodation of design changes. In addition, efficiency of the coupling and/or uncoupling the male and female connectors in the connector assembly may be substantially enhanced as a relatively small coupling and/or disengaging force is used, thereby allowing easy egress in emergency situations, such as medical emergencies, for example.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A connector assembly, comprising:
a first connector comprising a pilot terminal and a plurality of first terminals;
a second connector comprising a plurality of second terminals, wherein the second connector is configured to be releasably coupled with the first connector;
a housing disposed about the second connector and in operative association with the second connector; and
a coupling mechanism in operative association with the second connector, wherein the coupling mechanism is configured to aid in coupling the first connector and the second connector with use of a first force, and wherein the coupling mechanism comprises a lever mechanism having a Clevis mechanism,
wherein the pilot terminal is configured to facilitate coupling of the first connector and the second connector.

2. The assembly of claim 1, wherein the first connector comprises a male connector and the second connector comprises a female connector.

3. The assembly of claim 1, wherein the coupling mechanism comprises a parallel bar configuration, a hinge mounted configuration, a sliding block configuration, or a combination thereof.

4. The assembly of claim 1, wherein the coupling mechanism is further configured to aid in uncoupling the first connector and the second connector with use of a second force, wherein a direction of the second force is opposite to a direction of the first force.

5. The assembly of claim 1, wherein the coupling mechanism comprises a lever, a fixed portion, a working portion and a fulcrum portion.

6. The assembly of claim 5, wherein the lever comprises an adjustable lever, wherein a length of the adjustable lever is altered to vary the first force.

7. The assembly of claim 5, wherein the fulcrum portion of the coupling mechanism is in operative association with a second end of the second connector.

8. The assembly of claim 5, wherein the Clevis mechanism is disposed on the working portion of the coupling mechanism, and wherein the Clevis mechanism is configured to aid in coupling or uncoupling the first connector and the second connector with use of the first force.

9. The assembly of claim 8, wherein the second connector has a cavity configured to facilitate coupling of the pilot terminal with the Clevis mechanism.

10. The assembly of claim 1, wherein the assembly is configured for use in an imaging system, wherein the imaging system comprises one of a computed tomography imaging system, a positron emission tomography imaging system, a magnetic resonance imaging system, an X-ray imaging system, a nuclear medicine imaging system, an ultrasound imaging system, or a combination thereof.

11. A connector assembly, comprising:
a first connector comprising a pilot terminal and a plurality of first terminals;
a second connector comprising a cavity and a plurality of second terminals, wherein the plurality of second terminals is configured to mate with the plurality of first terminals; and
a lever assembly comprising a lever and having a first end and a second end, wherein the first end of the lever is configured to pull the pilot terminal of the first connector through the cavity of the second connector to facilitate coupling the first connector and the second connector.

12. The assembly of claim 11, wherein the first end of the lever is further configured to push the pilot terminal through the cavity to facilitate uncoupling the first connector and the second connector.

13. The assembly of claim 11, wherein the lever is configured to pull the pilot terminal through the cavity with use of a first force to facilitate coupling the first connector and the second connector.

14. The assembly of claim 13, wherein the lever is adapted to push the pilot terminal through the cavity with use of a second force to facilitate uncoupling the first connector and the second connector, wherein a direction of the second force is opposite to a direction of the first force.

15. A method of releasably coupling a first connector and a second connector in a connector assembly, the method comprising:
releasably coupling the first connector having a pilot terminal and a plurality of first terminals with a second connector having a plurality of second terminals via a coupling mechanism, wherein the coupling mechanism comprises a lever mechanism having a Clevis mechanism and is in operative association with the second connector.

16. The method of claim 15, further comprising applying a coupling force in a first direction to move the first connector having the pilot terminal and the plurality of first terminals in the first direction toward the second connector having the plurality of second terminals, wherein the plurality of first terminals is configured to be mateably coupled with the plurality of second terminals, and wherein the coupling force is configured to facilitate coupling the first connector and the second connector.

17. The method of claim 16, wherein releasably coupling the first connector to the second connector comprises:
disposing the Clevis mechanism in a cavity in the second connector;
coupling the pilot terminal of the first connector with the Clevis mechanism; and
continuing application of the coupling force in the first direction to couple the plurality of first terminals in the first connector with the plurality of second terminals in the second connector.

18. The method of claim 16, further comprising uncoupling the first connector and the second connector.

19. The method of claim 16, wherein uncoupling the first connector and second connector comprises:
applying an uncoupling force in a second direction, wherein the uncoupling force is configured to uncouple the first connector and the second connector, and wherein the second direction is opposite the first direction; and
continuing application of the uncoupling force in the second direction to uncouple the pilot terminal from the Clevis mechanism.

20. The method of claim 19, further comprising:
uncoupling of the plurality of first terminals and the plurality of second terminals.

21. The method of claim 15, further comprising adjusting a length of a lever of the coupling mechanism to vary the first force.

22. A system for imaging, comprising:
an acquisition subsystem configured to acquire image data, wherein the acquisition subsystem comprises a connector assembly, and wherein the connector assembly comprises:
a first connector comprising a pilot terminal and a plurality of first terminals;
a second connector comprising a plurality of second terminals, wherein the second connector is configured to be releasably coupled with the first connector;
a housing disposed about the second connector and in operative association with the second connector,
a coupling mechanism in operative association with the second connector, wherein the coupling mechanism is configured to aid in coupling the first connector and the second connector with use of a first force, and wherein the coupling mechanism comprises a lever mechanism having a Clevis mechanism; and
a processing subsystem in operative association with the acquisition subsystem and configured to process the acquired image data.

23. The system of claim 22, wherein the first connector comprises a male connector and the second connector comprises a female connector.

24. The system of claim 22, wherein the coupling mechanism is further configured to aid in uncoupling the first connector and the second connector with use of a second force, wherein a direction of the second force is opposite to a direction of the first force.

25. The system of claim 22, wherein the coupling mechanism comprises a parallel bar configuration, a hinge mounted configuration, a sliding block configuration, or a combination thereof.

26. The system of claim 22, wherein the coupling mechanism comprises a lever, a fixed portion, a working portion and a fulcrum portion.

27. The system of claim 26, wherein the fulcrum portion of the coupling mechanism is in operative association with a second end of the second connector.
